(19) United States
(12) Patent Application Publication
(10) Pub. No.: US 2012/0206691 A1
(43) Pub. Date: Aug. 16, 2012

(54) DYNAMIC MULTIFOCAL CONTACT LENS

(76) Inventor: Benjamin T. Iwai, Marshall, MO (US)

(21) Appl. No.: 13/370,528

(22) Filed: Feb. 10, 2012

Related U.S. Application Data
(60) Provisional application No. 61/441,517, filed on Feb. 10, 2011.

(51) Int. Cl. G02C 7/04

(52) U.S. Cl. 351/159.03

(57) ABSTRACT

An dynamic multiple focus contact lens has at least one transparent layer with a first annular electromagnet and a second annular electromagnet, a transparent pupil allowing passage of light through the at least one layer, at least one loop antenna in communication with the electromagnets, and a transmitter for activating the electromagnets. The at least one layer has a first shape similar to a circular segment that follows the surface of the cornea. The first shape has a first focal length, or power. Upon initiation by a user, a transmitter sends a signal to the loop antenna which energizes the electromagnets to mutually attract causing the at least one layer to deflect and the central portion of the first layer to deform outwardly forming the layer into a second shape. The second shape has a second power, stronger than the first shape.

### CROSS-REFERENCE TO RELATED APPLICATION

This non-provisional application claims priority to the pending provisional application 61/441,517 filed on Feb. 10, 2011 which is owned by the same inventor.

### BACKGROUND OF THE INVENTION

The adjustable power contact lens generally relates to optometry and more specifically to adjustable focal length lenses for the eye. The invention relates to a contact lens placed upon an eye that has an initial focal length and then a second focal length upon energizing embedded electromagnets.

Over the last three centuries, people have corrected vision problems, such as blurry vision, using solid transparent lenses. The lenses have been placed in frames and worn external of the affected eyes, typically known as eyeglasses or glasses. The lenses may have a single focal length, or power, or multiple powers such as in bi-focals and tri-focals. Multiple power lenses can be made of stacked pieces of lens, with the known bifocal line showing. Recently developments though have merged various powers of lens into a single lens though of varying thickness and select portions of the field of vision.

Glasses of single or multiple powers may work well for most individuals. The glasses though remain upon a person's face and may affect their self-image. In recent decades, optometry has developed contact lenses that have a smaller diameter and thickness for resting directly upon the cornea of an eye. Contact lenses come in hard lens and soft lens versions where the hard lens, or rigid gas permeable lens, corrects distance vision of a person. Hard lenses of single or multiple power cooperate with the eyelids to permit blinking yet retain a centered position over the eye pupil for corrected vision. Soft lenses rest upon the cornea of an eye and mold to the surface of the cornea. The soft lenses, in following the corneal shape, remain upon the cornea during blinking. More precisely, the soft lenses occupy the same location on the cornea relative to the optical axis of the eye during, before, and after an eyeblink.

However, the soft lenses though present a difficulty for multiple power construction. The soft lens' ability to remain in place also limits its ability to provide a second power. Usually, an eye gazes through a second axis to see at a second power, such as in bifocal glasses. The soft lens though remains oriented upon one axis.

The soft lens seeks to modify the focal power of the lens within an eye. The eye lens, inwardly from the cornea, provides the focusing for images at a range of about twenty feet or less, usually called near vision. The eye lens comes from concentric protein layers that move well during the youth of a person but then gradually thicken and lose pliability over the years. Reaching the age of forty years, many people then encounter difficulty in focusing because of this eye lens thickening, or presbyopia, where the eye decreases its refractive power. Presbyopia manifests as an inability to focus on near objects. In prior art bifocal spectacle design, vision undergoes correction by presenting the eye with two different lenses, one to correct vision at a distance, and a second more powerful lens—with a steeper curvature—to correct for near viewing. The power of the second lens equals the distance corrective refractive power plus an add power. The add power comes from the additional power, stated in diopters, needed to correct the vision of a person viewing a near target. Normal add powers range from +1.00 to +2.50 diopters. Some patients with severe visual impairment may require greater add power. These add powers remain in addition to the patient's distance correction. For example, if a patient requires a +2.00 diopter lens to see at distance and an optometrist determines that the patient requires a +1.50 diopters add power, the total lens power through the smaller near lenses thus equals +3.50 diopters. For advanced presbyopes, the eye has lost so much capability that it requires a third lens in front of the eye, a trifocal. Typically, trifocals have a main lens with distance correction, a smaller lens for near viewing, and an even smaller, third band shaped lens between the first two lenses. The smaller lens includes the patient's distance correction plus and the additional +2.50 diopters of spherical lens power. The third lens though has an intermediate amount of power, usually the distance correction plus an additional

+1.25 diopters for viewing objects in an intermediate range between near and far.

### DESCRIPTION OF THE PRIOR ART

Over the years, various soft lens designs have sought to provide a second power on the same visual axis. The prior art includes a lens with multiple refractive surfaces upon the lens' visual axis. Such lenses include refractive islands, concentric power rings, aspheric rings, and diffractive rings among others. But these devices focus light from varying distances through the cornea and upon the retina at the same time and place. The person then sees multiple exposures of an image resulting in a degraded view of an image, that is stacked, blurry images.

The U.S. patent to luliano, U.S. Pat. No. 7,699,464 has a multifocal contact lens operated using hydrodynamics, but on a small scale. The luliano lens includes a reservoir in communication with refractive surfaces and a transparent fluid within the reservoir. The reservoir generally locates below the visual axis of the lens. To adjust the power of this lens, luliano has the lens located upon the eye with the reservoir beneath the lower eyelid. The person then moves the eyelid and eye to compress the reservoir and move the fluid between the refractive surfaces, generally upon the visual axis of the lens. As the fluid separates the refractive surfaces, the power of the lens changes to the desired level. This type of lens though calls for a properly inserted and positioned lens and a trained eyelid to work the lens.

In an Optical Society of America paper, Hongbing Fan describes a variable focus lens formed from movement of fluid from a reservoir into a chamber under pressure from a solenoid actuated piston upon the reservoir. The chamber and reservoir communicate through a channel, all within the same substrate. This lens mechanism though calls for shifting fluid from one part to another upon application of an external force, here through a piston connected to a solenoid exterior to the substrate.

The patent to Kuiper, U.S. Pat. No. 7,311,398 describes a variable focus lens that includes two immiscible fluids 16, 17 in a cavity between a front wall 6 and a rear wall 8. The two fluids have a common meniscus 4. An annular first electrode 18 supplies a charge to the front wall 6 while a second electrode 21 contacts the second fluid to impart a charge. Upon supplying voltage to the electrodes, the meniscus attains different curvature altering the refractive index of the lens. However, the exterior shape of the lens remains constant. Though this patent shows an annular electrode upon one of two walls in a lens, this patent does not describe closing one wall upon another and guiding one fluid to deform one wall.

The patent to Large, U.S. Pat. No. 5,712,721, describes a switchable lens encapsulated within an outer coating. A power source communicates to the switchable lens through switching means, all generally upon the lens itself. The Large patent describes various bi-refringent lenses placed within liquid crystals that change their properties upon incidence of polarized or colored light. On the other hand, the present invention has a fluid that maintains its fluid properties as constant while one layer adjoins another layer upon application of a voltage.

The publication to Pugh, No. 2010/0103369, provides an apparatus for activating an energized ophthalmic lens. The publication mentions an energized lens, see para. 0004, but does not describe such a lens in detail. The publication does show a magnetic field utilized to operate the energized lens in FIG. 2.

The patent to Blum, U.S. Pat. No. 7,018,040, shows a stabilized electro active contact lens. This patented lens includes an electro active element and a view detector. The electro active element provides vision improvement to the user upon supply of an electric charge. The element may include polymer gels, liquid crystals, pixilated grid elements, transparent electrodes and insulators, and similar devices. The view detector ascertains the orientation of the user's eye using rangefinders, tilt switches, gyroscopes, and like devices. The deformation of a lens by two layers does not appear in this patent.

Then the patent to Azar, U.S. Pat. No. 7,402,175, provides a method to orient a vision prosthesis. This method includes implanting at least one magnet into the eye of a person and providing an optical element, such as a lens, with at least one counterpart magnet. The magnets from the eye and the optical element have opposite polarity thus attracting the optical element to the eye. This patent shows usage of permanent magnets but not electromagnets.

Turning to the patent to Tsuetaki, U.S. Pat. No. 4,693,572, it shows a single contact lens with two focal powers. The lens has an upper half at a first radius of curvature and a lower half at a second radius of curvature. FIG. 13 shows a device for manufacturing the lens. This patent does not utilize magnets or a fluid compressed between two layers.

The patent to Seidner, U.S. Pat. No. 5,002,382, provides a pair of multifocal contact lenses. The patent specifies one lens for each eye of a patient. One lens has a distant vision correction zone proximate the center and a near vision correction zone outwardly of the center. The other lens has the correction zones reversed. FIG. 39 shows various radii of curvature upon the interior of a lens for vision correction. This patent though does not disclose usage of magnets or fluids within a lens.

Seidner has a second patent, U.S. Pat. No. 5,898,473, on another pair of contact lenses. Each lens has a concave posterior surface and a convex anterior surface. The anterior surfaces include the vision correction zones. In claim 12, the patent clearly states only two vision correction zones and the zones are within 1.5 diopters of each others. This patent also omits disclosure of magnets and fluids in the lenses.

The patent to Volker, U.S. Pat. No. 5,971,542, illustrates a bi-focal contact lens with near vision correction below far vision correction upon the lens. The lens also has two thickened regions that assure its position relative to an eyelid of the user. The lens also has a colored spot that aids in setting the lens upon the eye of the user. Though this patent shows bifocal vision correction, it does not describe two layers with fluid between them subject to repositioning using magnets.

The patent to Lang, U.S. Pat. No. 6,231,603, provides an accommodating intraocular lens. This lens replaces an organic lens of a mammalian eye. This lens generally connects to the ciliary muscle of an eye. The lens then moves axially to adjust its focal power. Though this lens patent discusses movement, it describes haptics having a hinge, not magnets temporarily joining layers.

The patent to Chapoy, U.S. Pat. No. 6,808,262, illustrates a contact lens with an aspheric surface. The aspheric surface has an eccentricity that varies with the equatorial angle. This lens has two surfaces but no gap between the surfaces similar to the space between the layers of your invention. This patent also does not disclose usage of magnets or fluids.

The patent to Portney, U.S. Pat. No. 6,814,439, shows a multifocal contact lens that provides continuous variation in far to near vision correction. The lens has transition zones, shown as rings in FIG. 4, that provide for changes in focal power without edges, or steps in viewing to the wearer. This patent though describes a single lens without magnets or usage of fluid.

The patent to Shimojo, U.S. Pat. No. 7,819,523 comes from Japanese roots. This patent is in a slightly different order than the others. This patent shows an ocular lens of noticeable variation in thickness as shown in FIG. 2. The thickness changes along a vertical axis through the front surface of the lens. The claims also refer to a specific formula regarding power distribution. The claims also mention a rotation preventing mechanism and a toric surface for the back of the lens. Though this patent shows an outer surface of varying thickness, the lens does not utilize a compressed fluid formed by magnetism.

And, the patent publication to Carter, No. 2001/0028434, shows a bifocal contact lens. This lens has a front surface with an upper distance correction region and a lower near vision correction region. The publication specifies that the upper region exceeds the lower region in surface area though both share a common center point. The lens also has a perimeter region. This lens though does not use magnetism nor a liquid to adjust its focal power.

The present invention overcomes the disadvantages of the prior art and provides an adjustable power contact lens that changes its power upon a remote signal and with a single, deformable chamber for fluid in the lens. The present invention does not utilize the eyelids or other ocular musculature for its operation. The present invention also provides a cosmetic touch with various colorations of the lens or sub-layer of the lens. The present invention allows a person to place it upon an eye readily and then adjust its power by a manual transmitter.

### SUMMARY OF THE INVENTION

Generally, the adjustable power contact lens has a first transparent layer with a first annular electromagnet, a transparent core, a second transparent layer with a second annular electromagnet, a transparent pupil allowing passage of light through the layers and the core, a loop antenna in communication with the electromagnets, and a transmitter for activating the electromagnets. The first layer, core, and second layer have a first shape similar to a circular segment that follows the surface of the cornea. The first shape has a first focal length, or power, for distance vision correction. Upon initiation by a user, the transmitter sends a signal to the loop antenna which energizes the electromagnets into opposite polarity. The electromagnets then mutually attract causing the core to flow inwardly entirely within the pupil and the central portion of the first layer to deform outwardly forming the layers and the core into a second shape. The second shape has a second power, generally stronger than the first shape and for near vision correction. The second shape provides the central portion of the first layer as a somewhat spherical shape. There has thus been outlined, rather broadly, the more important features of the invention in order that the detailed description thereof that follows may be better understood and that the present contribution to the art may be better appreciated. The present invention also includes a soft first layer and a hard second layer, a liquid or a gel core, a loop antenna embedded in each layer, a manually activated transmitter, the transmitter having a near range only, coloration included in the first layer masking the first electromagnet, an alternate embodiment of one electromagnet and a ferrous material, and an alternate embodiment including a solar cell. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide an adjustable power contact lens that changes power without introduction of solution into a person's eye and without application of external mechanical force.

Another object is to provide such an adjustable power contact lens that changes power without removal of it from an eye.

Another object is to provide such an adjustable power contact lens that allows presbyopic persons to use their near vision and view nearby objects without changing contacts or wearing eyeglasses.

Another object is to provide such an adjustable power contact lens that has a low cost of manufacturing so the purchasing people, optometrists, clinics, hospitals, business establishments, and organizations can readily buy the adjustable power contact lens through catalogs, suppliers, vendors, and supply sources.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 shows a front view of the invention;

FIG. 2 describes a rear view of the invention;

FIG. 3 provides a section view of the invention;

FIG. 4 illustrates a section view of the invention after activation of the loop antenna;

FIG. 5 shows a front view of an alternate embodiment of the invention;

FIG. 6 describes a rear view of an alternate embodiment of the invention;

FIG. 7 provides a section view of an alternate embodiment of the invention;

FIG. 8 illustrates a section view of an alternate embodiment of the invention after activation of the loop antenna;

FIG. 9 shows a front view of a second alternate embodiment of the invention;

FIG. 10 describes a rear view of a second alternate embodiment of the invention;

FIG. 11 provides a section view of a second alternate embodiment of the invention;

FIG. 12 illustrates a section view of a second alternate embodiment of the invention after activation of the loop antenna;

FIG. 13 shows a front view of an alternate embodiment of the invention;

FIG. 14 describes a rear view of an alternate embodiment of the invention;

FIG. 15 provides a section view of an alternate embodiment of the invention;

FIG. 16 illustrates a section view of an alternate embodiment of the invention after activation of the loop antenna;

FIG. 17 shows a front view of an alternate embodiment of the invention;

FIG. 18 provides a side view of a transmitter to activate the invention; and,

FIG. 19 describes a front view of an alternate embodiment of the invention.

The same reference numerals refer to the same parts throughout the various figures.

### DESCRIPTION OF THE PREFERRED EMBODIMENT

The present art overcomes the prior art limitations by providing an adjustable power contact lens in one or more layers of lens material. As this description and drawings relate to contact lenses which are small, the drawings show an enlarged view of a lens and not to scale.

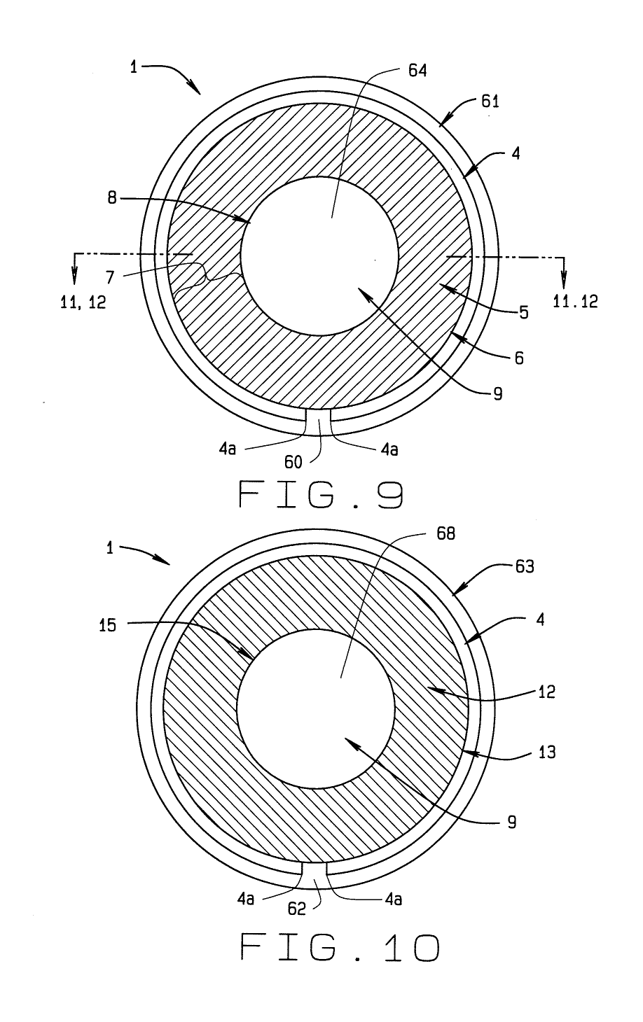

In the single layer design of FIGS. 1-4 and the dual layer design without a core of FIGS. 9-12, the lens material between the electromagnets and that material which displaces under their force has elastic properties. These elastic properties cause the lens material to return to its original shape upon removal of the force of the electromagnets, that is removal of electric current. The return of the lens material occurs independently of the forces applied by any other layer, such as the cornea, or aspect of the lens because the lens material stores tension within the displaced material itself. Thus removal of electric charge releases the tension and the lens material returns to its at rest state and shape.

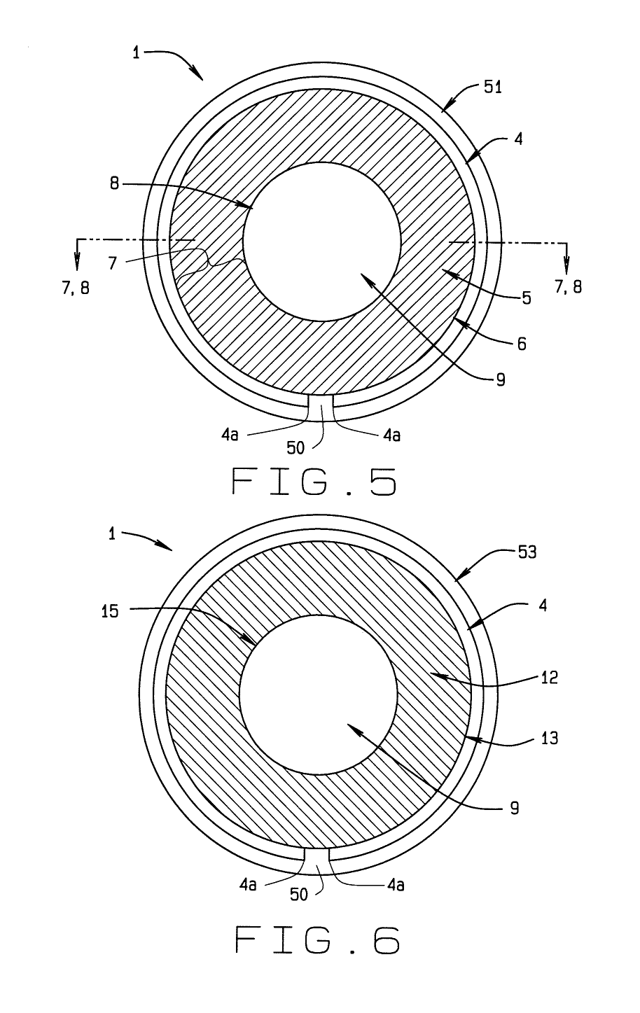

In later embodiments of dual layer design with a core, FIGS. 5-8, 13-16, as a liquid layer becomes more like a gel—hence more elastic—this distinction dissolves and both mechanisms remain in effect and both contribute to the lens resuming its original shape. Some may argue that these two mechanisms operate differently. However as a liquid approaches a solid, that is grows higher in viscosity, the liquid itself returns to a generally at rest state and brings the surrounding lens layers as to their original shape, that is the at rest shape. As the core remains liquid, its low viscosity allows all the core, or fluid, between the electromagnets to displace outwardly from the electromagnets. No tension is stored within the fluid and the fluid has no elastic properties. All of the tension required to return the material to its initial state is stored within the outer or first layer as it bows outwards, the first layer is preferably a soft gel as later described. When the electromagnets are disengaged the force of the first layer pressing on the liquid forces it in between the electromagnets, separately them until needed for use later.

The present invention begins with mathematical descriptions of swelled layers from a multifocal aspect to a single focal aspect. First, the Applicant has identified the mathematical description for the surface shapes of a single layer dynamic multifocal lens before and after activation for a “normal eye” as described by the Gullstand-Emsley No. 1 eye, well known in the optometry field. In this sample case, a Gullstand No. 1 eye has no correction needed other than a +2.50 diopters add, such as for an advanced presbyopic patient. Generally, the radius of curvature of the back surface of a soft contact lens, or CL, or Base Curve Radius, or BCR, matches the curvature of a patient's cornea. The curvature of the cornea is measured using a device called a keratometer which measures the radius of curvature of the cornea and then converts that value into diopters using the fundamental paraxial equation with a corneal index of refraction of 1.3375. The terms are considered interchangeable in optometry but by convention corneas are described by their refractive power measured in diopters. The average cornea has a refractive power of 43.00 diopters. The average cornea comes from when if one sampled the world's human population the Gaussian distribution of cornea power would be about 43.00 diopters with about 90% of the population having plus or minus 6.00 diopters of this mean value.

So, the formula for the power of a spherical lens begins with the paraxial equation. This equation describes the refractive power of a single surface, for example, light passing from air into glass. Here the spherical lens power comes from:

$$F = ( \frac{n - {n}^{′}}{r} ) \qquad A )$$

where:
F=focal power of cornea in diopters=43.00 D
n=refractive index of air=1.0
n′=refractive index of the lens, here the cornea)=1.3375
r=radius of curvature of the lens=7.85 mm
   thus, the back surface radius of curvature for a CL equals 7.85 mm.

The above formula, while extensively used to calculate BCR for hard contacts, is not used for soft contacts. This happens because first, the cornea is not a perfect spherical surface though practitioners treat it as such, and second the material of the soft CL is so gel-like. As to the shape of the cornea, while very nearly spherical in the center, where practitioner's measure and have greatest interest, the cornea becomes flatter at its periphery. Therefore most soft CL manufactures use a rather larger BCR for their lenses because a typical soft CL has enough BCR and size to cover the cornea and more. Typical soft CL have a diameter of 12-14 mm while a cornea has an 11 to 12 mm diameter. To account for the decrease in sphericity of the cornea the lenses must have a larger BCR. As to the material of the soft CL, the material has so much so gel-like properties that it drapes the cornea and molds itself to fit as long as it is not too far off from the cornea's natural curvature. For any given soft CL, a manufacturer will release between one and three BCR for the same lens, usually 8.2 mm, 8.6 mm, and 9.0 mm. Typically the manufacturer will provide a list to an optometrist with the suggested CL BCR for a given patient's corneal power. For example, a cornea with a power of 43.00 D would get the 8.6 BCR soft CL lens. However, no two CL manufacturers are exactly the same in this regard.

The above formula still closely describes both the curvature of the cornea and the back surface curvature of the dynamic multifocal lens in the patent, at least near the central optical zone. An optical engineer then adjusts the curvature formula around the periphery for a final product.

The next question for lens design involves determining the refractive index of the material (n). The refractive index of most contact lens materials ranges from about 1.44 to about 1.37. The Applicant notes that an index of 1.40 fits within the central range for soft CL materials. So presuming n′=1.40 and the BCR is 7.85 then the power of the back surface is −51 D, using the above formula. From there, determination begins for the front surface radius of curvature of the dynamic multifocal lens when not engaged if we know the back surface radius of curvature and power. For thin lenses the equation is:

Front surface power+Back surface power=total lens power

By removing F, n and n′ in the preceding equation and the Applicant has determined an intuitive answer of total lens power equals 0.00 D if the front surface radius of curvature equals the back surface radius of curvature, that is, 7.85 mm. Building upon this analysis, the Applicant accounts for the thickness of the lens utilizing the Gullstrand equation:

$$Total\_power = F 1 + F 2 - ( \frac{t}{{n}^{′}} ) * F 1 * F 2 \qquad B )$$

where:
F1=power of the front surface=+50.78 diopters
F2=power of the back surface=−51.00 diopters
t=thickness in meters of the lens=for most CL 0.12 mm
n′=refractive index of the lens material=1.40
and Total Power=0 in lens disengaged state

The above equation describes a two layer thick lens system such as when light passes into a glass lens of some thickness and then into air again. A calculator for this equation using a single lens can be found here:

C) http://hyperphysics.phy-astr.gsu.edu/hbase/geoopt/gullcal.html

Using the above formula and accounting for the lens thickness, the Applicant using the equation calculates a front surface power, F1, of about +50.78 D, slightly weaker than the thin lens equation would suggest. Then, the Applicant converts that power back to a radius of curvature for the front using the fundamental paraxial equation to determine a radius of curvature for the front surface in its disengaged state as about 7.88 mm, slightly flatter than the back surface which typically has a back radius of curvature of 7.85 mm. Applying similar analysis, the power of the front surface F1 increases from about +50.78 diopters to +53.27 diopters, which includes the +2.50 diopter add to the initial lens prescription and corresponds to radius of curvature of 7.51 mm in the engaged state of the lens. The back surface power remains unchanged.

Using the above formula, the equation calculates the power of the lens when engaged. The total power should be +2.50 diopters added to the initial lens prescription thus the Applicant utilized the above equation, the Gullstrand calculator, and the following values:
Front surface power=+53.267 diopters
Back surface power=−51 diopters
Thickness≈0.12 mm
index of refraction=1.40
and Total Power=+2.50 diopters in lens engaged state
   Therefore the front surface power calculates as +53.267 diopters with a front surface radius of curvature of 7.51 mm. The Applicant notes that the power of a lens increases as the radius of curvature decreases such as shown here as a lens moves from its disengaged to its engaged state.

The Applicant now proceeds to calculate the change in volume and height of a CL under action of the present invention's magnetism. For that, the Applicant seeks the optical zone diameter where a typical optical zone diameter would be about 8.0 mm. To perform the calculation, the Applicant begins with the volume of the engaged, or swelled, state and subtracts the volume of the disengaged, or rest, state of the CL. The Applicant suggests utilizing a dome geometric calculator such as that found at:

D) http://www.monolithic.com/stories/dome-calculator

Utilizing such a calculator, the Applicant entered the following values of the engaged lens: diameter=8 mm and height=1.154 mm which results in a radius of curvature of the dome formed at 7.51 mm—the calculated front surface radius of curvature and having a volume of the dome as 29.81 mm³. For the disengaged state of a lens, the Applicant entered the following values: diameter 8 mm and height=1.090 mm which results in a radius of curvature of the dome formed at 7.88 mm and a volume of the dome as 28.07 mm³. Subtracting the volume at the engaged state from the disengaged state yields a small volume change as 29.81−28.07=1.74 mm³.

Turning to the action of the invention, the Applicant proceeds to determine the amount of material displaced by the electromagnets. Though the drawings apparently show the electromagnets as rings, in their two dimensional representation, the electromagnets have an actual form of an annular slice from a domed shape. The following analysis serves as a best estimate of the shape and volume of the electromagnets though the Applicant foresees fluctuations in dimensions during manufacturing.

The volume analysis for the electromagnets begin with a cylinder of 13 mm diameter and height of 0.043 mm, then subtract a cylinder with a diameter of 8 mm and a height of 0.043 mm. The Applicant utilizes the cylinder volume formula of:

V=π*r²*h E)

Resulting in π*6.5²*0.43−π*4²*0.043=3.55 mm³ or twice the amount of material needed for displacement by the invention's magnets. The Applicant utilizes an outer radius of an electromagnet of 6.5 mm and an inner radius of an electromagnet of 4.0 mm in the preceding formula, where the radius is half of the diameter. The Applicant allows for leakage of half the material outside of the electromagnet rings. Thus, the Applicant asserts that the distance between the electromagnets becomes approximately 0.043 mm for magnets that are 2.5 mm wide and positioned inside of the lens. The Applicant notes that the distance between the electromagnets may decrease if their width increases. This latest analysis presumes all of the lens material displaces upon actuation of the electromagnets, this lens is possible in a core liquid layer lens but unlikely in a gel lens. The electromagnets will take up a certain thickness in addition to the displaced material so the total thickness at the periphery is approximately more than 0.043 mm depending on the thickness of the electromagnets imbedded in the contact lens hydrogel matrix. As long as the lens thickness does not exceed 0.3-0.4 mm, a patient will not detect the lens, patients tend to feel lenses of greater thickness. The present invention embeds its electromagnet within the material without altering the thickness and without increasing the detection of the lens by a patient. The thickest hard contact lens may have a thickness as great as 0.5 mm but this can sometimes cause decentration problems.

With volume determined, the Applicant proceeds to determining the electrical power for the electromagnets. The following draws on three website calculators:

F) http://www.daycounter.com/Calculators/Magnets/Solenoid-Force-Calculator.phtml
G) http://www.circuits.dk/calculator_flat_spiral_coil_inductor.htm
H) http://circuitcalculator.com/wordpress/2007/09/20/wire-parameter-calculator/
Starting with 40 gauge wire (0.07874 mm diameter) we use the calculator provided here:
I) http://hyperphysics.ph4-aftr.vsu.edu/hbase/veoopp/vulltal.html
with a central zone of 8 mm diameter, no spacing between the wires, and a single layer solenoid with 32 turns determines an outer diameter of 13 mm.
Outer diameter=13 mm
Inner diameter=8 mm
wire diameter=0.07874 mm
number of turns=32
   the total thickness of the lens would be 0.07874 mm+0.07874 mm+0.043 mm=˜0.2 mm plus some thickness to completely embed the electromagnets yielding an approximate lens thickness of 0.25 mm.

Using daycounter.com/calculator/magnets/solenoid-force-calculator.phtml;

we calculate that the ampacity of 40 gauge wire as 0.226 amps.

So using these calculators:

G) http://www.circuits.dk/calculator_flat_spiral_coil_inductor.htm
H) http://circuitcalculator.com/wordpress/2007/09/20/wire-parameter-calculator/
We enter the following data:
Current=0.226 amps
Number of turns=32
Area=82.467 mm² (=π*6.5²−π*4²)
Gap between electromagnets=0.043 mm
which yields 0.329 pounds of pressure for one electromagnet. The Applicant notes that that value can be doubled because the invention utilizes two electromagnets. The Applicant notes that 0.66 pounds of pressure probably exceeds that needed by the invention. However, the Applicant has started with a higher value to make the lens of the invention thinner, smaller, and to use less electrical power.

The power requirements of the electromagnets are described by the formula:

Power (watts)=Current²(amps)*Resistance (ohms)

P=I²R J)

So utilizing this data:

I=0.226 amps
R=3.64 ohms (resistance per foot (1.048) times the length of the wire (3.47 ft))

yields a power of 0.186 watts for each electromagnet. The Applicant notes that this power is far less than that of cell phone.

The preceding power serves as the activation energy for the electromagnets. Upon engaging the invention and the electromagnets attain apposition then the power requirement drops over ten fold. This occurs because the forces produced by the electromagnets are inversely proportional to the distance between them. The present invention though does require a small maintenance current applied continuously to keep the invention in its engaged state. The maintenance current through the electromagnets keeps them in apposition once activated. The maintenance current typically has a magnitude of about 0.0223 amps based on the above solenoid force calculator: the maintenance current is approximately one tenth of the activation current. The maintenance current presumes that the electromagnets approach to within 0.005 mm of each other and that a minimum force of about 0.474 lbs will keep the electromagnets together and prevent premature separation of them. The Applicant notes that removing the maintenance current allows the lens material to return to its rest state, separates the electromagnets, puts the lens 1 into a disengaged state, and the lens then provides distance vision correction.

And, if the present invention has excess capacity in terms of power to run the device, the Applicant notes a few relationships lead to further optimizing of the invention during application. Increasing the diameter of the lens or decreasing the size of the optical zone allows for increasing the width of the electromagnet rings. This increases the area of the rings and decreases the gap between the electromagnets for the same volume displaced thus decreasing the power required to operate the lens. This increase though leads to a side effect of reducing the ability of oxygen to permeate to the cornea and will reduce the amount of wearing time for the lens. Practitioners will have to inform patients of appropriate wearing times. Using thinner wires can increase the number of wire turns upon the electromagnets, reduce the thickness of the electromagnets and decrease the power requirement but smaller wires have a limit to the amount of current they can carry due to increasing length and electrical resistance. More power sent to the lens will produce more heat but as long as the maximum activation energy occurs intermittently, not continuously, then the generated heat appears insignificant with little risk to a patient. Regarding the electromagnets, they have a very thin cross section for their fit inside the lens. The electrical power of the electromagnets is small and over a short time. The force produced by the electromagnets has sufficient strength to displace the lens material, or later core material. The heat generated by the electromagnets of the invention is negligible.

In this embodiment and others, the present invention operates as follows: that upon activation of a transmitter, the power receivers energize and polarize each electromagnet in the lens which provides a second shape to the lens, particularly its front, or outer surface. The front surface has a second optical characteristic for near vision correction from about +0 diopter to about +3.0 diopters. The second optical characteristics happens when two electromagnets mutually attractive, or alternatively a single electromagnet attracts to a ferrous ring and a portion of the front surface swells within the first electromagnet outwardly from the rear surface, putting the lens in an engaged position. After activating the transmitter and the front surface attaining its swollen state, the power receivers delivers a maintenance current, lesser than the current that activated the lens, which keeps the electromagnets, or alternatively one electromagnet and a ferrous ring in apposition but with less power demand. The maintenance current flows until a user inactivates the transmitter. So, upon inactivation of the transmitter, the first electromagnet separates from the second, or alternatively the electromagnet separates from a ferrous ring, and the front surface and thus the lens returns to its disengaged position.

Now turning to FIG. 1, it shows a front view of the invention 1 of the preferred embodiment with a single layer with its single layer 40 of soft lens material in the foreground. The single layer has a generally transparent construction and round shape with a diameter proportional to the iris of a person. The first layer has a round first edge 41 defining its perimeter. Inwardly from the first edge, the lens of the invention 1 has a power receiver, here shown as a loop antenna 4 that generally follows the first edge though at slightly less diameter. The power receiver accepts a radio signal and converts the signal into electrical current. The antenna has two terminals 4a here shown spaced apart though proximate each other. The terminals connect the antenna 4 to the first electromagnet 5 that has a round annular shape with an outer edge 6 slightly less in diameter than the loop antenna. The outer edge defines the maximum width of the first electromagnet.

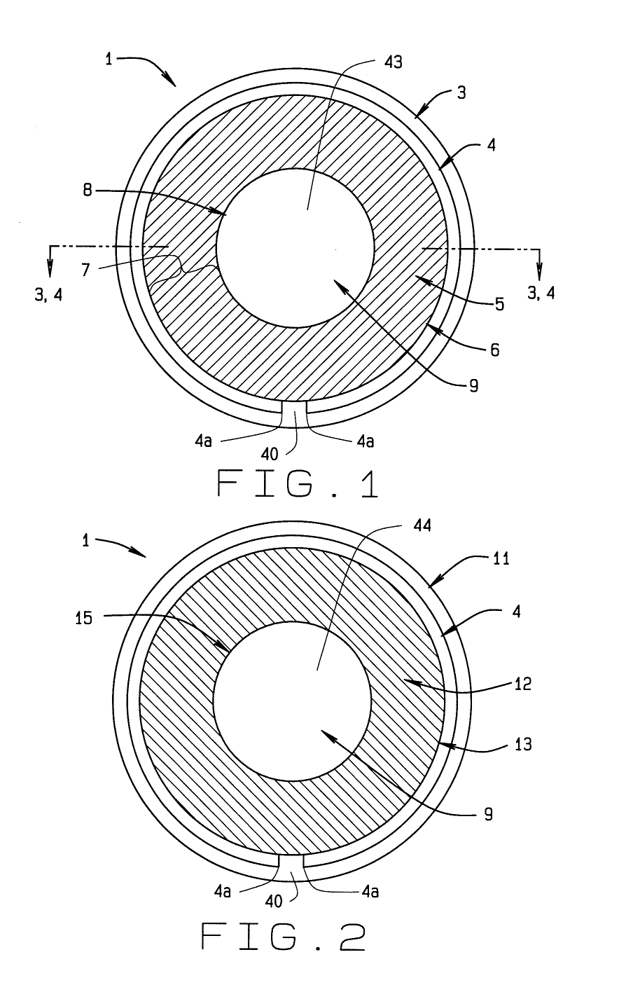

Generally, the present invention comprises a contact lens with two annular electromagnets embedded in the lens. The electromagnets have a preferred circular form that provides the desired shape when engaged that produces the optical spherical or aspherical lens surface for vision correction of a user. Upon engagement, the electromagnets mutually attract, producing a force that compresses a portion of the material of the lens causing displacement of the lens material outside and more inside of each electromagnet ring. The nature of the lens material, such as a liquid, a gel, a deformable solid, or a material between those known states, provides sufficiently low viscosity so that small amounts of force displace the lens material from between the electromagnets as later shown in FIG. 2. Furthermore at least one wall of the central, optical zone or the displaced material itself must have sufficient elasticity so that upon removal of the force from the electromagnets, the lens material returns completely to its original shape, as it was before application of the force. Most hydrogel or silicone-hydrogel materials have sufficient elasticity to meet this requirement. Typically the preferred materials of the invention refer to elastic materials. Elastic materials differ from shape memory materials which retain their new shape until a new stimulus applies to the material, not simply the removal of the force which reshaped them.

The first electromagnet has its width, as at 7, generally proportional to the human iris. The inner diameter of the electromagnet marking the outer edge of the optical zone is the typical optical zone of a RGP CL. The inner diameter has a minimum size of 8 mm. Inwardly from the outer edge and the width 7, the first electromagnet has its inner edge 8. Generally the inner edge is similar to that of the inside diameter of a human iris. Preferably, the inner edge has a diameter similar to the inside diameter of the iris during daylight and with the eye gazing beyond twenty feet. The inner edge 8 defines the perimeter of a pupil 9, generally transparent through which light passes into the eye during usage of the invention. For the present invention, the lens 1 outer diameter is usually determined by the diameter of an average cornea, 11-12 mm, and not the iris. Soft lenses have a little larger diameter, 13-14 mm, and hard lenses, RGP, have a little smaller diameter, 9-10 mm. This variation in outer diameters comes from how the materials, hardness, and shape of the lens interact with the eyelids as the eye blinks and how the lens rests on the cornea. For the present invention, its outer diameter is based on the typical dimensions of a soft contact lens, the material of the first, or outer layer.

In cooperation with a transmitter, later described in FIG. 18, the power receiver, or loop antenna 4, and the first electromagnet 5 cooperate for polarizing it into an operating electromagnet. In one method, the loop antenna polarizes the electromagnet using resonant inductive coupling or electrodynamic induction. Such coupling provides for the near field wireless transmission of electrical energy between two coils where the two coils highly resonate at the same frequency. Such coupling employs resonance with a high Q and often utilizes an air core. The two coils in such a coupling may exist within a single piece of equipment or occupy two separate pieces of equipment as in the present invention with its power receiver, or loop antenna 4, and transmitter.

Resonant transfer operates by making a coil ring with an oscillating current, generating an oscillating electromagnetic field. Because the transmitter has high resonance any energy placed in the coil fades away relatively slowly over oscillation cycles; but if a second coil approaches it, the coil picks up most of the energy before its loss, even at greater distances. The field created in the invention is generally a predominately non-radiative, near field where hardware kept well within a ¼ wavelength distance radiates little energy from the transmitter outwardly to infinity. The power receiver operates using either resonant inductive coupling or resonant transfer.

Having described powering the first electromagnet 5, it requires another item to attract to it during usage of the invention. FIG. 2 shows a rear view of the invention 1 opposite FIG. 1. Inwardly from the first edge, the second layer of the invention 1 has another loop antenna 4 that generally follows the second edge though at slightly less diameter. The loop antenna of the second layer is generally concentric with the first layer antenna. The antenna of the second layer also has two terminals 4a here shown spaced apart though proximate each other. The terminals connect the antenna 4 to the second electromagnet 12 that also has a round annular shape with its outer edge 13 slightly less in diameter than the loop antenna. The outer edge defines the maximum width of the second electromagnet, generally similar to that of the first electromagnet. The second electromagnet has its width, as at 7, generally no more than the width of a human iris at rest and also similar to that of the first electromagnet. Inwardly from the outer edge and the width 7, the second electromagnet has its inner edge 15. The inner edge 15 defines the perimeter of a pupil 9 similar to that of FIG. 1 so that both pupils align and provide a generally transparent path through the layer of the lens through which light passes into the eye during usage of the invention. The inner edge has a diameter of approximately 8 mm, similar to that of a pupil. In an alternate embodiment, the second electromagnet is replaced with a ferrous material that does not receive electrical current and does not have a connection to a power receiver.

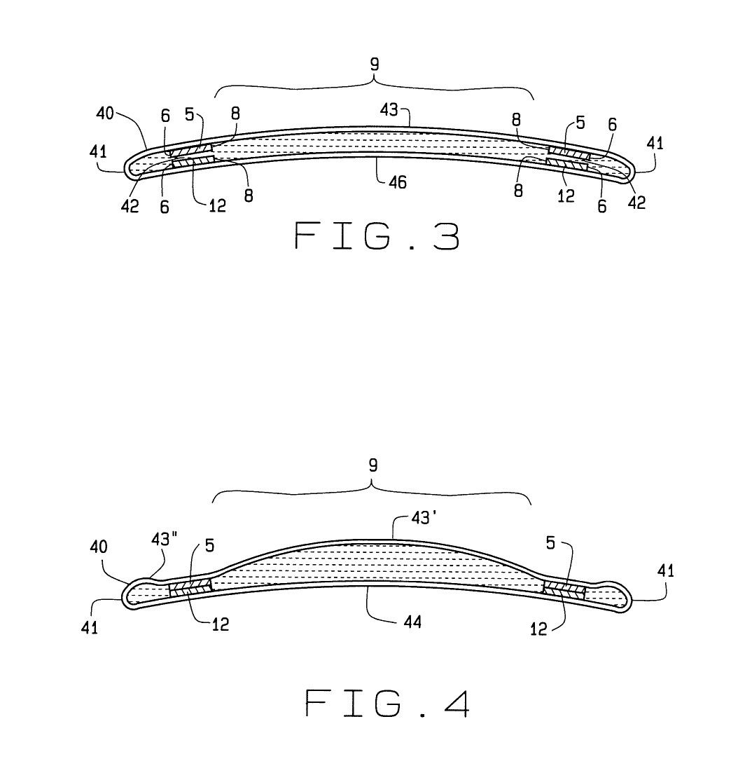

FIG. 3 then shows a sectional view through the invention 1 generally along a diameter. The invention has its layer 40 of lens material which has a front surface 43 generally located away from a patient's cornea when installed and an opposite back surface 44 generally located upon a patient's cornea. This view shows the invention before application of electrical power and the front surface and the back surround remain approximately parallel. The layer has its first edge 41 here shown similar to a wall, because at this enlargement of the invention, the lens has its thickness and a generally cylinder like shape. The first edge spans between the front surface and the back surface upon the entire perimeter of the lens. Depending from the front surface, the invention includes the first electromagnet 5. Because of the annular like shape of the electromagnet, the sectional view has shown the electromagnet as two spaced apart rectangles. Opposite the first electromagnet, the back surface has a second electromagnet 12. The second electromagnet has the same shape as the first electromagnet and appears as two spaced apart rectangles as shown. Between the first electromagnet and the second electromagnet, the layer includes a gap 42 of in the range of about 0.035 to about 0.060 mm. When the invention is disengaged, the material of the layer 40 fills the gap between the two electromagnets. The two electromagnets remain inwards from the first edge 41 as shown by their lesser diameter of their outer edges 6. The two electromagnets have similar width 7 and the same inner diameter 8 to form a pupil 9, or optical zone, of constant diameter within the two electromagnets.

Then the time comes for the patient to correct his vision. FIG. 3 shows the invention with electrical power applied to the first electromagnet 5 having one polarity and applied to the second electromagnet 12 having the opposite polarity. Upon application of electrical power, the first electromagnet attracts itself to the second electromagnet closing the gap 42 of FIG. 2 entirely, thus the lens of the invention 1 has attained an engaged state. The first electromagnet touches the second electromagnet upon their mutual perimeters and upon their common width so that a pupil of constant diameter remains. In doing so, the first electromagnet displaces lens material formerly within the gap. The lens material moves outwardly from the electromagnets and more so inwardly from the electromagnets. As the lens material moves, or deflects, the front surface swells outwardly as at 43′ into a spherical shape of the desired diopters for suitable vision correction. The swelled front surface 43′ is no longer generally parallel to the back surface 44 as shown. The back surface retains its cornea fitting curvature while the front surface 43′ has a greater curvature thus increasing focusing power. Outwardly from the first electromagnet, the front surface decreases the apparent thickness of the invention, as at 43″, proximate the first electromagnet and then the material of the lens returns to its normal thickness shown as the height of the first edge 41. Though this embodiment describes a first electromagnet outwardly from the second electromagnet, the Applicant foresees embodiments utilizing multiple spaced apart rings for each electromagnet.

### Embodiment 2

FIG. 5 shows a front view of the second embodiment of the invention 1 with its first layer 50 in the foreground. This first layer is of soft contact lens material where soft material adapts to the corneal surface immediately. The first layer is of transparent construction and round shape with a diameter proportional to the iris of a person. The first layer has a round first edge 51 defining its perimeter. Inwardly from the first edge, the lens has the loop antenna 4 that generally follows the first edge though at slightly less diameter and has its two terminals 4a. The terminals connect the antenna 4 to the first electromagnet 5 as described above. The outer edge defines the maximum width of the first electromagnet.

Generally, this embodiment comprises a contact lens with two annular electromagnets embedded in the layers of the lens as later shown. The electromagnets have a preferred circular form that provides the desired shape when engaged for vision correction of a user. Upon engagement, the electromagnets produce an attractive force that compresses one layer upon the other and a core causing displacement of the core and swelling of the first layer 50. The nature of the core such as a liquid, a gel, a deformable solid, or a material between those known states, provides sufficiently low viscosity so that small amounts of force displace the core in the reduced volume of the lens between the electromagnets. Furthermore, the first layer has the central, optical zone, and the first layer has sufficient elasticity to return completely to its original shape, as before application of the force. Most hydrogel or silicone-hydrogel materials have sufficient elasticity to meet this requirement. Typically the preferred materials of the invention refer to elastic materials, not shape memory materials.

As above, the first electromagnet has its width, as at 7, generally proportional to the human iris. The inner diameter of the electromagnet marking the outer edge of the optical zone is the typical optical zone of a RGP CL. The inner diameter has a minimum size of 8 mm. Inwardly from the outer edge and the width 7, the first electromagnet has its inner edge 8. Generally the inner edge is similar to that of the inside diameter of a human iris. Preferably, the inner edge has a diameter similar to the inside diameter of the iris during daylight and with the eye gazing beyond twenty feet. The inner edge 8 defines the perimeter of a pupil 9, generally transparent through which light passes into the eye during usage of the invention. For the present invention, the lens 1 outer diameter is usually determined by the diameter of an average cornea, 11-12 mm, and not the iris. Soft lenses have a little larger diameter, 13-14 mm, and hard lenses, RGP, have a little smaller diameter, 9-10 mm. This variation in outer diameters comes from how the materials, hardness, and shape of the lens interact with the eyelids as the eye blinks and how the lens rests on the cornea.

In cooperation with a transmitter, later described in FIG. 18, the loop antenna 4 and the first electromagnet 5 cooperate for polarizing of the electromagnet. The loop antenna polarizes the electromagnet using resonant inductive coupling or electrodynamic induction. Such coupling provides for the near field wireless transmission of electrical energy between two coils that highly resonate at the same frequency, using a high Q and often an air core. The two coils in such a coupling may exist within a single piece of equipment or occupy two separate pieces of equipment as in the present invention with its loop antenna 4 and transmitter.

Resonant transfer operates by making a coil ring with an oscillating current, generating an oscillating electromagnetic field. Because the transmitter has high resonance any energy placed in the coil fades away relatively slowly over oscillation cycles; but if a second coil approaches it, the coil picks up most of the energy before its loss, even at greater distances. The field created in the invention is generally a predominately non-radiative, near field where hardware is kept well within a ¼ wavelength distance radiates little energy from the transmitter outwardly to infinity.

Though this embodiment describes one ring each for the upper and lower electromagnets, the Applicant foresees embodiments utilizing multiple concentric rings for each electromagnet. With the addition of multiple conjugated rings, the number of different power steps decreases between plus zero diopter to the lens' disengaged state with its maximum power of +2.50 diopters. A single conjugated ring pair has two states: distance correction at plus zero diopter, or disengaged, and distance correction at a plus sum of diopters as measured by the optometrist for desired vision correction, often using a phoropter. Then adding a second conjugated ring pair inside the first pair produces an embodiment of a trifocal design. But, activating only the outer ring of electromagnets displaces less material and so changes the curvature of the front surface less than upon activating both ring pairs, yielding a reduced add power. Activating the inner ring next displaces then more material of the first layer and brings the lens to its maximum add power. Then also, activating the inner ring without activating the outer ring yields an intermediate add power, such as one power less than if both rings were activated but more power than if only the peripheral ring were activated. Further, from an energy efficiency standpoint, the invention foresees activating the electromagnet pairs from outer most to inner most because the crescent shaped cross-section of the contact lens dictates a greater gap distance between an electromagnet pair nearer to the center of the lens than an electromagnet pair closer to the periphery of the lens. A greater distance requires more energy to move the electromagnets into apposition. Activating the outer magnets first brings the electromagnets of the inner ring closer together, so long as they are close enough to the outer ring. This reduction in distance reduces the amount of energy to activate the inner ring. And as in trifocal spectacle glasses, most patients will not need more than three powers from their lenses: distance, intermediate near, and near. So any advantage of having 3, 4, or 5 concentric rings decreases as the number of rings increases.

Having described powering the first electromagnet 5, the first electromagnet requires another item to attract to it during usage of the invention. FIG. 6 shows a rear view of the invention 1 opposite FIG. 5 but with its second layer 52 in the foreground of this figure. The second layer, also of soft contact lens material as in the first layer, has a transparent construction and round shape with a diameter proportional to the iris of a person. The second layer is approximately the same diameter as the first layer. The second layer 52 also has its round second edge 52 defining its perimeter and that merges with the outer edge 51 as later shown. Inwardly from the second edge, this embodiment has a second antenna 4 that generally follows the second edge though at slightly less diameter. The loop antenna of the second layer is generally concentric with the first layer antenna and has two terminals 4a as described above. The terminals connect the antenna 4 to the second electromagnet 12 of a round annular shape with its outer edge 13 slightly less in diameter than the loop antenna. The outer edge defines the maximum width of the second electromagnet as similar to that of the first electromagnet. The second electromagnet has its width similar to that of the first layer as at 7. The second electromagnet has its inner edge 15 that defines the perimeter of a pupil 9 that aligns with the pupil of the first layer 50 for a transparent path through which light passes into the eye during usage of the invention. The inner edge has a diameter of approximately 8 mm, similar to that of a pupil. In an alternate embodiment, the second electromagnet is replaced with a ferrous material that does not receive electrical current and does not have a connection to a power receiver.

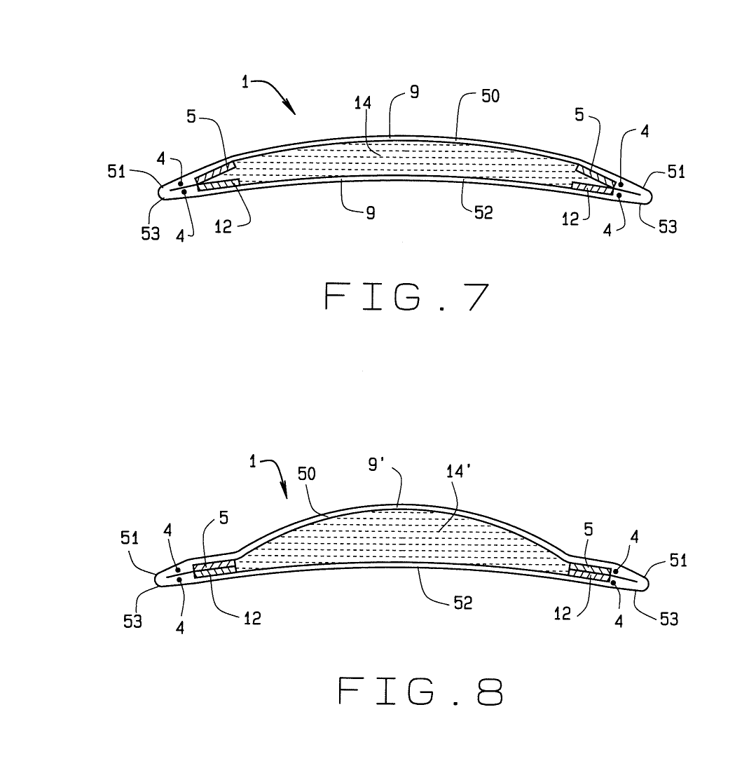

Turning to FIG. 7, the invention appears in a section view where the first layer 2 and the second layer 10 surround a core 14 of transparent liquid, or alternatively gel. In this embodiment, the core, or liquid chamber, acts to transfer the force produced by the attractive electromagnets on to the first layer, that is, the front elastic layer, because of a liquid's incompressibility and the liquid swells towards the location of least resistance of its container. Further, the tension stored within the first layer, or the elastic layer, when deformed by the core as in FIG. 8, causes the first layer to return to its original shape upon disengagement of the electromagnets. This return to its original shape occurs when the elastic layer applies pressure on the core thus forcing liquid in the core back between the spaced apart, de-energized electromagnets. The core, by itself, has no innate tendency to resume the original shape of the lens. The core does so because the force of the electromagnets no longer exceeds the force of the elastic layer, to return to its rest state. With the elastic layer exceeding the electromagnetic force, the lens material flattens itself along with the core beneath it.

The first lateral edge 51 joins to the second lateral edge 53 upon the entire perimeter of the lens in a generally combined taper with a rounded over edge for comfort when worn. When combined, the first lateral edge and the second lateral edge have a smooth shape—crescent like—suitable for placement upon the cornea of an eye. The first lateral edge and the second lateral edge retain the core 14 interiorly of them and do not allow for leakage of the core from the lens of the invention 1. The first lateral edge and the second lateral edge mutually join using adhesives, cohesives, thermal treatments and the like. Inwardly from the first lateral edge and the second lateral edge, the first layer 50 and the second layer 52 each have their loop antennae 4 as described above. As shown, the first layer, the second layer, and the core define a first shape—the disengaged position—similar to a circular segment where the second layer follows the surface of the cornea, opposite the core and the first layer. The first layer has a curved shape pleasing to the inside of the eyelid. This first shape has a first focal length, or power, generally for far vision, that is, beyond twenty feet. The core also spaces apart the first electromagnet 5 and the second electromagnet 12 somewhat like a wedge. In this spacing, the first electromagnet and the second electromagnet mutually approach each other outwardly, that is, towards the lateral edges 51, 53. While the first electromagnet 5 and the second electromagnet 12 mutually diverge inwardly towards the inner edges 7, 15 at the pupil 9.

Then in FIG. 8, upon initiation by a user, the transmitter, as later described in FIG. 18, sends a signal to the loop antennae 4 which energizes the electromagnets 5, 12 into opposite polarity. The electromagnets 5, 12 then mutually attract bringing the first electromagnet upon the second electromagnet and causing material of the core 14 formerly between the magnets to flow inwardly entirely within the pupil 9. This flow swells the first layer so the central portion 9′ deforms outwardly thus making the layers 2, 10 and the core 14 into a second shape, the engaged position. The second shape allows for the desired vision correction. The Applicant has identified the dimensions of a “typical” lens utilized in the invention. The Applicant has utilized a preferred 1.40 refractive index within the range of about 1.3 to about 1.6 refractive index for the lens material.

The material, displaced from between the electromagnets and forced towards the center of the lens, causes the central optical zone to swell outwardly and upwardly at the front surface of the contact lens because of to the shape constraints of the central chamber. The electromagnets themselves form akin to a wall around the outside of the optical zone of the lens. The back of the optical zone chamber retains its cornea friendly shape as the second layer has much less elasticity than the first later. Because of the less elastic second layer, only the elastic front surface swells outward reshaping the lens and thus changing its optical power.

The second shape has a generally flat form but with an acute circular section of greater thickness than the core of the first shape in FIG. 7. Here the core provides a thickness that alters the path of incident light at a second power, generally stronger than the first shape. The second shape provides the central portion 9′ of the first layer 2 as a somewhat spherical shape as shown, centered upon the optical axis of the lens of the invention 1. As shown, the loop antennae 4 energize from the signal and impart current to the electromagnets 5, 12 of opposite polarity causing them to mutually attract nearly instantaneously. The electromagnet attraction compresses the core 14 inwardly but the core attains a somewhat spherical shape 14′ as the first layer 9 deforms as at 9′. The material of the first layer has sufficient flexibility and elasticity to accommodate its deformation without degrading the optical characteristics of the first layer. The core 14′ retains its optical characteristics though in a spherical shape. The mutual joint of the first lateral edge and the second lateral edge also withstands the deformation of the first layer and mutual compression of the two layers.

### Embodiment 3

FIG. 9 shows a front view of the third embodiment of the invention 1 with its first layer 60 in the foreground. This first layer is of soft contact lens material that adapts to the corneal surface immediately. The first layer is of transparent construction and round shape with a diameter proportional to the iris of a person. The first layer has a round first edge 61 defining its perimeter. Inwardly from the first edge, the lens has the loop antenna 4 that generally follows the first edge though at slightly less diameter and has its two terminals 4a for connecting to the first electromagnet 5 as described above. The outer edge 6 defines the maximum width of the first electromagnet.

Generally, this embodiment comprises a contact lens of two layers in a piggyback arrangement with two annular electromagnets, one embedded in each of the two layers of the lens but without a core as later shown. The electromagnets have a preferred circular form that provides the desired shape when engaged for vision correction of a user. Upon engagement, the electromagnets produce an attractive force that compresses one layer upon the other and swells the first layer 60 into an optically desired shape. The nature of the lens material such as a gel, a deformable solid, or a material between those known states, provides sufficiently low viscosity so that small amounts of force displace the material of the first layer into the reduced volume of the lens between the electromagnets. Furthermore, the first layer has the central, optical zone, and the first layer has sufficient elasticity to return completely to its original shape, as before application of the force. Most hydrogel or silicone-hydrogel materials have sufficient elasticity to meet this requirement. Typically the preferred materials of the invention refer to elastic materials, not shape memory materials.

As above, the first electromagnet has its width, as at 7, also generally proportional to the human iris. The inner diameter of the electromagnet marking the outer edge of the optical zone is the typical optical zone of a RGP CL. The inner diameter has a minimum size of 8 mm. Inwardly from the outer edge and the width 7, the first electromagnet has its inner edge 8. Generally the inner edge is similar to that of the inside diameter of a human iris. Preferably, the inner edge has a diameter similar to the inside diameter of the iris during daylight and with the eye gazing beyond twenty feet. The inner edge 8 defines the perimeter of a pupil 9, generally transparent through which light passes into the eye during usage of the invention. For the present invention, the lens 1 outer diameter is usually determined by the diameter of an average cornea, 11-12 mm, and not the iris. Soft lenses have a little larger diameter, 13-14 mm, and hard lenses, RGP, have a little smaller diameter, 9-10 mm. This variation in outer diameters comes from how the materials, hardness, and shape of the lens interact with the eyelids as the eye blinks and how the lens rests on the cornea.

In cooperation with a transmitter, later described in FIG. 18, the loop antenna 4 and the first electromagnet 5 cooperate for its polarizing. The loop antenna polarizes the electromagnet using resonant inductive coupling or electrodynamic induction as described above.

Though this embodiment describes one ring each for the upper and lower electromagnets, the Applicant foresees embodiments utilizing multiple concentric rings for each electromagnet. With the addition of multiple conjugated rings, the number of different power steps decreases between plus zero diopter to the lens' disengaged state with its maximum power of +2.50 diopters. A single conjugated ring pair has two states: distance correction at plus zero diopter, or disengaged state, and distance correction at a plus amount of diopters, including the initial prescription of the lens, or its engaged state. Then adding a second conjugated ring pair inside the first pair produces an embodiment of a trifocal design. But, activating only the outer ring of electromagnets displaces less material and so changes the curvature of the front surface less than upon activating both ring pairs, yielding a reduced add power. Activating the inner ring next displaces then more material of the first layer and brings the lens to its maximum add power. Then also, activating the inner ring without activating the outer ring yields an intermediate add power, such as one power less than if both rings were activated but more power than if only the peripheral ring were activated. Further, from an energy efficiency standpoint, the invention foresees activating the electromagnet pairs from outer most to inner most because the crescent shaped cross-section of the contact lens dictates a greater gap distance between an electromagnet pair nearer to the center of the lens than an electromagnet pair closer to the periphery of the lens. A greater distance requires more energy to move the electromagnets into apposition. Activating the outer magnets first brings the electromagnets of the inner ring closer together, so long as they are close enough to the outer ring. This reduction in distance reduces the amount of energy to activate the inner ring. And as in trifocal spectacle glasses, most patients will not need more than three powers from their lenses: distance, intermediate near, and near. So any advantage of having 3, 4, or 5 concentric rings decreases as the number of rings increases.

Having described powering the first electromagnet 5, it requires another item to attract to it during usage of the invention. FIG. 10 shows a rear view of the invention 1 opposite FIG. 9 but with its second layer 62 in the foreground of this figure. The second layer, of hard contact lens material unlike the first layer, has a transparent construction and round shape with a diameter proportional to the iris of a person. A hard lens material replaces the natural shape of the cornea a new refracting surface but the material requires a time period for the eye to adapt to its inflexible shape, in contrast to the immediate adaptation to soft lens material. As before, the second layer 62 has approximately the same diameter as the first layer and its round second edge 63 defining its perimeter and that merges with the outer edge 61 as later shown. Inwardly from the second edge, this embodiment has a second antenna 4 that generally follows the second edge though at slightly less diameter. The loop antenna of the second layer is generally concentric with the first layer antenna and has two terminals 4a as described above and connecting it to the second electromagnet 12 of a round annular shape with its outer edge 13 slightly less in diameter than the loop antenna. The outer edge defines the maximum width of the second electromagnet as similar to that of the first electromagnet. The second electromagnet has its width similar to that of the first layer as at 7. The second electromagnet has its inner edge 15 that defines the perimeter of a pupil 9 that aligns with the pupil of the first layer 60 and the second layer 62 for a transparent path through which light passes into the eye during usage of the invention. The inner edge has a diameter of approximately 8 mm, similar to that of a pupil. In an alternate embodiment, the second electromagnet is replaced with a ferrous material that does not receive electrical current and does not have a connection to a power receiver.

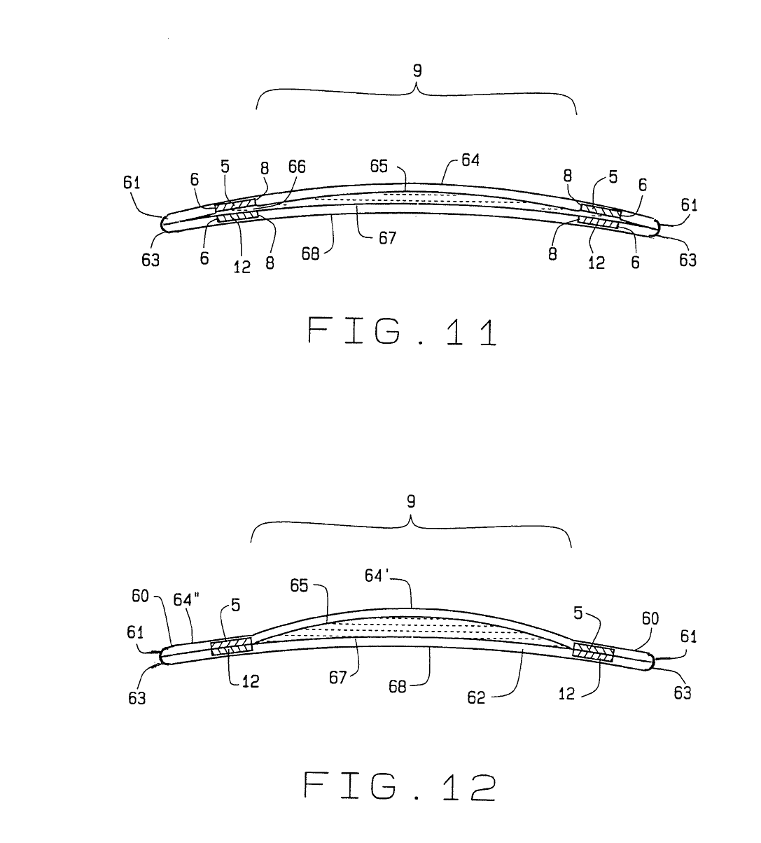

Turning to FIG. 11, in time a patient seeks to correct his vision. FIG. 11 then shows a sectional view through this third embodiment of the invention 1 generally along a diameter. The invention has its first layer 60 of soft lens material which has a front surface 64, outwardly from a patient's cornea, and an opposite rear surface 65 generally located upon the second layer 62 and the second layer 62 itself rests upon the patient's cornea. This view shows the invention before application of electrical power and the front surface 64, rear surface 65, and the second layer 62 remain approximately parallel. The first layer 60 has its first edge 61 here shown similar to a wall, because at this enlargement of the invention, the lens has its thickness between the front surface and the rear surface as shown and a generally cylinder like shape. The first edge spans between the front surface and the rear surface upon the entire perimeter of the lens. Depending from the front surface 64, the invention includes the first electromagnet 5. Because of the annular like shape of the electromagnet, the sectional view has shown the electromagnet as two spaced apart rectangles. The first electromagnet has a height less than the thickness of the first layer as shown. Opposite the first electromagnet, the second layer has the second electromagnet 12 embedded in it. The second layer includes its own front surface 67 and an opposite rear surface 68 where the rear surface of the second layer rests upon the patient's cornea. The second electromagnet has a position within the second layer so that the second electromagnet remains flush with the front surface 67. In the preferred embodiment, the second electromagnet has its own height generally similar to the thickness of the second layer. In a further alternate embodiment, the second electromagnet has its own height generally less than the thickness of the second layer.

The second electromagnet has the same shape as the first electromagnet and appears as two spaced apart rectangles as shown. Between the first electromagnet and the second electromagnet as shown, the first layer includes a gap 66 of in the range of about 0.035 to about 0.060 mm. The gap extends from the first electromagnet to the rear surface 65 within the first layer. When disengaged, the material of the first layer 60 fills the gap between the two electromagnets, that is, above the second electromagnet. The two electromagnets remain inwards from the first edges 61, 63 as shown by their lesser diameter of their outer edges 6. The two electromagnets have similar width 7 and the same inner diameter 8 to form a pupil 9, or optical zone, of constant diameter through the two electromagnets.

Next, FIG. 12 shows the invention with electrical power applied to the first electromagnet 5 having one polarity and to the second electromagnet 12 having the opposite polarity. Upon application of electrical power, the first electromagnet attracts itself to the second electromagnet closing the gap 66 of FIG. 11 completely, thus the lens of the invention 1 has attained its engaged state. The first electromagnet touches the second electromagnet upon their mutual perimeters and upon their common width so that a pupil 9 of constant diameter remains. In doing so, the first electromagnet displaces lens material of the first layer formerly within the gap 66. The lens material moves outwardly from the electromagnets and more so inwardly from the electromagnets. As the lens material moves, or deflects, the front surface 64 swells outwardly as at 64′ into a spherical shape of the desired diopters for suitable vision correction. The swelled front surface 64′ is no longer generally parallel to the rear surface 65 and the second layer 62 as shown. The second layer, more particularly its rear surface 68, retains its cornea fitting curvature while the front surface 64′ has a greater curvature thus increasing focusing power. Outwardly from the first electromagnet, the front surface 64 decreases the apparent thickness of the first layer, as at 64″, proximate the first electromagnet and then the material of the lens returns to its normal thickness shown as the height of the first edge 61. The second layer retains its thickness generally the same as in the disengaged state. The second layer's front surface 67 and rear surface 68 remain generally parallel and spanned by the outer edge 63. Though this embodiment describes a first electromagnet outwardly from the second electromagnet, the Applicant foresees embodiments utilizing multiple spaced apart rings for each electromagnet.

### Embodiment 4

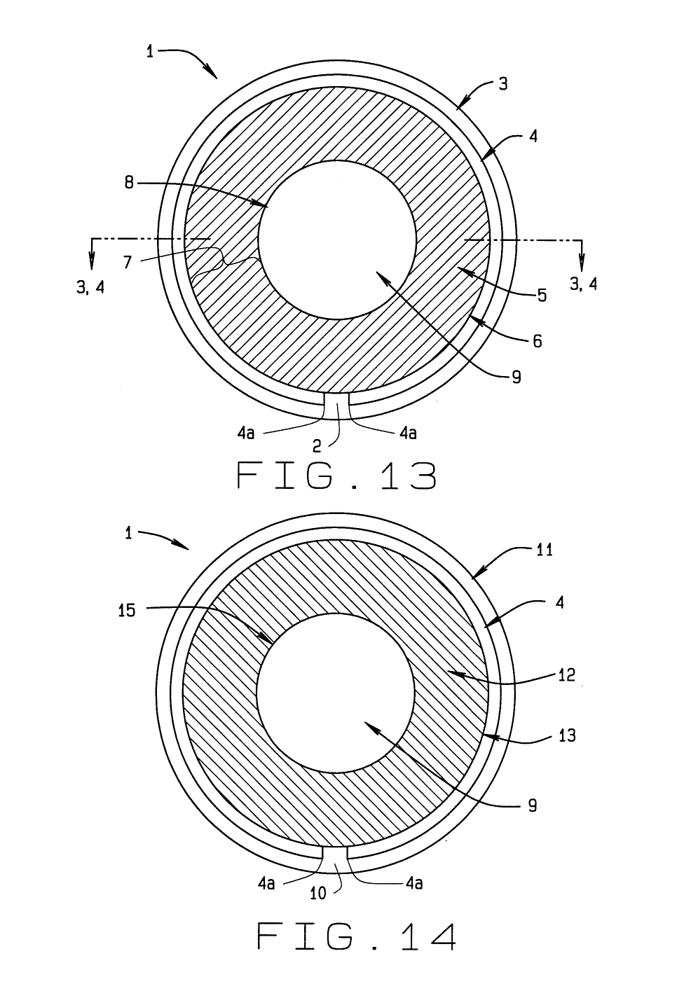

And the fourth embodiment provides at least two focal lengths, or powers in a single lens. FIG. 13 shows a front view of the invention 1 with its first layer 2 in the foreground. The first layer is of soft lens material that readily adapts to a patient's cornea and has a generally transparent construction and round shape with a diameter proportional to the iris of a person. The first layer has a round first edge 3 defining its perimeter. Inwardly from the first edge, the lens of the invention 1 has a loop antenna 4 that generally follows the first edge though at slightly less diameter. The antenna has two terminals 4a here shown spaced apart though proximate each other. The terminals connect the antenna 4 to the first electromagnet 5 that has a round annular shape with an outer edge 6 slightly less in diameter than the loop antenna. The outer edge defines the maximum width of the first electromagnet.

This embodiment comprises a contact lens with two annular electromagnets embedded in the two layers of the lens, in a piggyback like arrangement. The electromagnets have a preferred circular form that provides the desired shape when engaged that produces the optical spherical or aspherical lens surface for vision correction of a user. Upon engagement, the electromagnets produce a force that compresses a portion of the first layer of the lens upon the second layer causing displacement of the core both inside and outside of each electromagnet ring. The nature of the core, such as a liquid, a gel, a deformable solid, or a material between those known states, provides sufficiently low viscosity so that small amounts of force displace the lens material from between the electromagnets. Furthermore at least one wall of the central, optical zone or the displaced material itself must have sufficient elasticity so that upon removal of the force from the electromagnets, the first layer's material returns completely to its original shape, as it was before application of the force. Most hydrogel or silicone-hydrogel materials have sufficient elasticity to meet this requirement. The preferred materials of this embodiment refer to elastic materials. Elastic materials differ from shape memory materials which retain their new shape until a new stimulus applies to the material, not simply the removal of the force which reshaped them.

The first electromagnet has its width, as at 7, The first electromagnet has its width, as at 7, generally proportional to the human iris. The inner diameter of the electromagnet marking the outer edge of the optical zone is the typical optical zone of a RGP CL. The inner diameter has a minimum size of 8 mm. Inwardly from the outer edge and the width 7, the first electromagnet has its inner edge 8. Generally the inner edge is similar to that of the inside diameter of a human iris. Preferably, the inner edge has a diameter similar to the inside diameter of the iris during daylight and with the eye gazing beyond twenty feet. The inner edge 8 defines the perimeter of a pupil 9, generally transparent through which light passes into the eye during usage of the invention. For the present invention, the lens 1 outer diameter is usually determined by the diameter of an average cornea, 11-12 mm, and not the iris. Soft lenses have a little larger diameter, 13-14 mm, and hard lenses, RGP, have a little smaller diameter, 9-10 mm. This variation in outer diameters comes from how the materials, hardness, and shape of the lens interact with the eyelids as the eye blinks and how the lens rests on the cornea. Generally the inner edge is similar to that of the inside diameter of a human iris, approximately 8 mm. Preferably, the inner edge has a diameter similar to the inside diameter of the iris during daylight and with the eye gazing beyond twenty feet. The inner edge 8 defines the perimeter of a pupil 9, generally transparent through which light passes into the eye during usage of the invention.

In cooperation with a transmitter, later described in FIG. 18, the loop antenna 4 and the first electromagnet 5 cooperate for polarizing the electromagnet. In one method, the loop polarizes the electromagnet using resonant inductive coupling or electrodynamic induction. Such coupling provides for the near field wireless transmission of electrical energy between two coils where the two coils highly resonate at the same frequency as described above. Resonant transfer operates by making a coil ring with an oscillating current, generating an oscillating electromagnetic field as also described above. Though this embodiment describes one ring each for the upper and lower electromagnets, the Applicant foresees embodiments utilizing multiple rings for each electromagnet as also described above.

In another method, the lens 1 includes a photovoltaic cell, as the power receiver, in the first electromagnet towards the surface of the first layer. The photovoltaic cell produces electricity to polarize the first electromagnet upon completion of a circuit using a transmitter. The transmitter closes a switch allowing transfer of power from the cell to the electromagnet.

Having described powering the first electromagnet 5, it requires another item to attract to it during usage of the invention. FIG. 14 shows a rear view of the invention 1 opposite FIG. 1 but with its second layer 10 in the foreground of this figure. The second layer is of hard contact lens material that adapts slowly to the corneal surface and has a generally transparent construction and round shape with a diameter proportional to the iris of a person. The second layer is slightly larger in diameter than the first layer. The second layer 10 also has its round second edge 11 defining its perimeter. Inwardly from the second edge, the second layer of the invention 1 has another loop antenna 4 that generally follows the second edge though at slightly less diameter. The loop antenna of the second layer is generally concentric with the first layer antenna. The antenna of the second layer also has two terminals 4a here shown spaced apart though proximate each other. The terminals connect the antenna 4 to the second electromagnet 12 that also has a round annular shape with its outer edge 13 slightly less in diameter than the loop antenna. The outer edge defines the maximum width of the second electromagnet, generally similar to that of the first electromagnet. The second electromagnet has its width, as at 7, generally no more than the width of a human iris at rest and also similar to that of the first electromagnet. Inwardly from the outer edge and the width 7, the second electromagnet has its inner edge 15. The inner edge 15 defines the perimeter of a pupil 9 similar to that of the first layer 2 where both pupils align, have a minimum diameter of 8 mm, and provide a generally transparent path through both layers and the core which light passes into the eye during usage of the invention. In an alternate embodiment, the second electromagnet is replaced with a ferrous material that does not receive electrical current and does not have a connection to a power receiver.

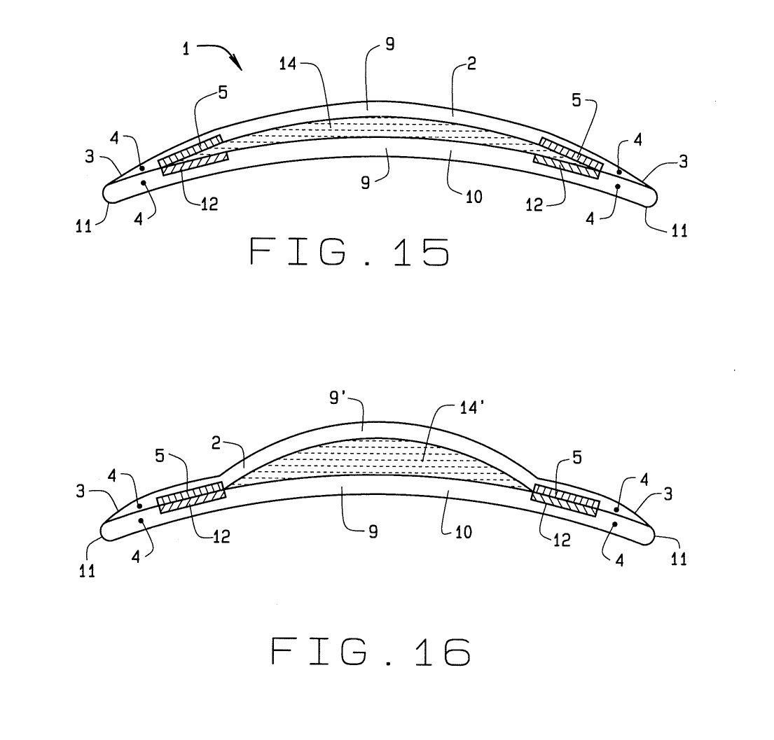

Turning to FIG. 15, the invention appears in a section view where the first layer 2 and the second layer 10 surround a core 14 of transparent liquid, or alternatively gel. In this embodiment, the core, or liquid chamber, acts to transfer the force produced by the electromagnets on to the first layer, that is the front elastic layer, or soft layer, because of a liquid's incompressibility and the liquid swells towards the location of least resistance of its container. Further, the tension stored within the first layer, or the elastic layer, when deformed by the core causes the first layer to return to its original shape upon disengagement of the electromagnets. This return to its original shape occurs when the elastic layer applies pressure on the core thus forcing liquid in the core back between the spaced apart, de-energized electromagnets. The core, by itself, has no innate tendency to resume the original shape of the lens. The core does so because the force applied by the elastic layer exceeds the force formerly applied by the energized electromagnets.

The first lateral edge 3 joins to the second lateral edge 11 upon the entire perimeter of the lens. The first lateral edge has a generally radially tapered shape while the second lateral edge has a generally constant thickness. When combined, the first lateral edge and the second lateral edge have a smooth shape—crescent like—suitable for placement upon the cornea of an eye. The first lateral edge and the second lateral edge retain the core 14 interiorly of them and do not allow for leakage of the core from the lens of the invention 1. The first lateral edge and the second lateral edge mutually join using adhesives, cohesives, thermal treatments and the like. Inwardly from the first lateral edge and the second lateral edge, the first layer 2 and the second layer 10 each have their loop antennae 4, generally concentrically arranged. As shown, the first layer, the second layer, and the core define a first shape similar to a circular segment where the second layer follows the surface of the cornea, opposite the core and the first layer. The first layer has a curved shape pleasing to the inside of the eyelid. This first shape has a first focal length, or power, generally for far vision, that is, beyond twenty feet. The core also spaces apart the first electromagnet 5 and the second electromagnet 12 somewhat like a wedge. In this spacing, the first electromagnet and the second electromagnet mutually approach each other outwardly, that is, towards the lateral edges 3, 11. While the first electromagnet and the second electromagnet mutually diverge inwardly to the inner edges 7, 15 at the pupil 9.

Then in FIG. 16, upon initiation by a user, the transmitter, as later described in FIG. 18, sends a signal to the loop antennae 4 which energizes the electromagnets 5, 12 into opposite polarity. The electromagnets 5, 12 then mutually attract causing the core 14 to flow inwardly entirely within the pupil 9 and the central portion 9′ of the first layer 2 to deform outwardly thus making the layers 2, 10 and the core 14 into a second shape.

The Applicant has identified the dimensions of a “typical” lens utilized in the invention. The Applicant has utilized a preferred 1.40 refractive index within the range of about 1.3 to about 1.6 refractive index for the lens material.

The material, displaced from between the electromagnets and forced towards the center of the lens, causes the central optical zone to swell outwardly and upwardly at the front surface of the contact lens because of to the shape constraints of the central chamber. The electromagnets themselves form akin to a wall around the outside of the optical zone of the lens. The back of the optical zone chamber comes from the second layer, that is, a ridged wall of transparent ridged gas-permeable material -GP or RGP-, or directly from the surface of the cornea upon which the lens rests. Because of the rigid back of the optical zone, only the elastic front surface swells outward reshaping the lens and thus changing its optical power.

The second shape has a generally flat form but with an acute circular section of greater thickness than the core of the first shape in FIG. 15. Here the core provides a thickness that alters the path of incident light at a second power, generally stronger than the first shape. The second shape provides the central portion 9′ of the first layer 2 as a somewhat spherical shape as shown, centered upon the optical axis of the lens of the invention 1. As shown, the loop antennae 4 energize from the signal and impart current to the electromagnets 5, 12 of opposite polarity causing them to attract to each other nearly instantaneously. The electromagnets' attraction compresses the core 14 inwardly but as liquid materials do not compress, the core attains a somewhat spherical shape 14′ as the first layer 9 deforms as at 9′. The material of the first layer has sufficient flexibility and elasticity to accommodate its deformation without degrading the optical characteristics of the first layer. The core 14′ retains its optical characteristics though in a spherical shape. The mutual joint of the first lateral edge and the second lateral edge also withstands the deformation of the first layer and mutual compression of the two layers.

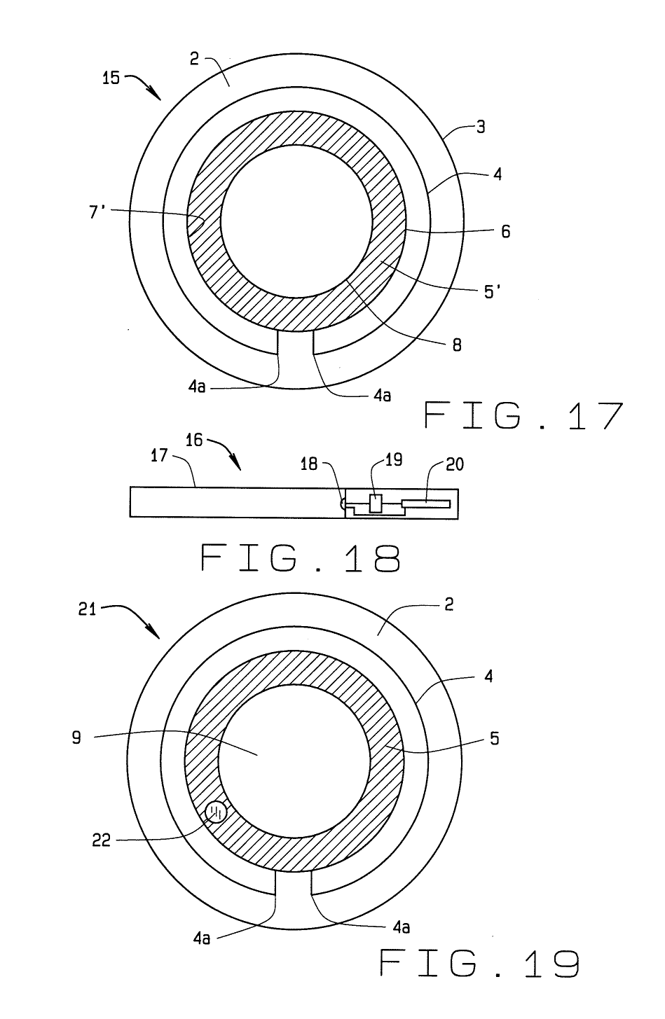

FIG. 17 then shows an alternate embodiment 15 of the invention 1 from the front. This embodiment utilizes two layers as described previously however, the electromagnets 5′, 12′ have a narrower thickness 7′. The narrower thickness spaces the electromagnet more inward from the antenna than in the preferred embodiment.

FIG. 18 provides a partial perspective view of the invention and its related transmitter 16 that operates the invention. The transmitter has a housing 17 here shown as an elongated tube, similar to a pen, though the Applicant foresees other forms and shapes for the transmitter in due course. The remote transmitter feeds power wirelessly to the device for its simple operation. The Applicant foresees embedding the power supply in the lens as a small battery or drawing the power from a photovoltaic cell. The Application also foresees a control mechanism as either external or internal such as a system that detects the angle or position of the eyes relative to each other or the horizon. Within the transmitter, the housing has a switch 18 in electrical communication with a battery 19 which then delivers power to a transmitting antenna 20. Upon pressing the housing axially, the switch compresses, completing a circuit so that the transmitting antenna emits a radio signal. The radio has sufficient strength to reach approximately four feet and to provide sufficient current in the loop antennae 4 energizing the electromagnets 5, 12. Upon release of the housing, the switch opens, breaking the circuit and ceasing transmission of the radio signal so that the electromagnets lose polarity and the core returns to its circular sector shape and the lens returns to its lower power.

FIG. 19 also shows a second alternate embodiment 21 of the lens where the first layer 2 has a electromagnet 5 and a loop antenna 4 as before but also at least one photovoltaic cell 22 in electrical communication to the first electromagnet 5. The cell energizes the first electromagnet so that the transmitter 16 may send a lower power radio signal than previously described.

The present invention in its preferred and alternate embodiments allows for usage of a single lens with two focal lengths, or powers. A user can place the lens 1 in an eye and leave it in place while enjoying the benefits of two powers. The user need not change between lenses to achieve other powers, that is vision correction. The single lens usage lessens the risk of allergic reaction of a user's eye from changing of lenses to utilize different powers.

In the preceding embodiments, electromagnets have description as being of single ring shape. However, the invention also includes multiple concentric rings of electromagnets as placed in the lenses that provide multiple additive optically corrective powers. The Applicant includes two, three, and upwards of four concentric electromagnets in a ring like shape. Generally the number of lens powers possible equals the number of electromagnet ring pairs. For example, if only the outer ring pair of a lens is engaged then the lens would attain its lowest add power but still greater than its disengaged power. But if all of the electromagnets were engaged, then the lens would reach its maximum add power.

From the aforementioned description, an adjustable power contact lens has been described. The adjustable power contact lens is uniquely capable of deforming a lens so that its core attains a somewhat spherical shape causing a second focal length, or power. The adjustable power contact lens utilizes a transmitter that sends radio waves to antennae in the lens that energize electromagnets of opposite polarity so that the electromagnets mutually attract and deform the lens. The adjustable power contact lens and its various components may be manufactured from many materials, including but not limited to, polymers, polyethylene, polypropylene, ferrous and non-ferrous metals, their alloys, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

The preceding electrical power and focal power requirements and parameters remain as estimates by the Applicant calculated with accepted engineering and optics formulas using reasonable assumptions and appropriate simplifications. The Applicant asserts that the electrical power and focal power requirements and parameters have not approached finality but rather show that the power requirements and shape changes the invention undergoes remain plausible and feasible given known engineering and optics principles. Actual power requirements will remain within a range of the values provided here depending on the exact focal power change designed into a lens for a given patient.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

I claim:

1. A dynamic multiple focus contact lens, said lens being suitable for application upon a human cornea and avoiding damage thereto, and said lens having an initial prescribed strength, comprising:
at least one layer having a generally round shape with a perimeter, front surface, an opposite rear surface, and an outer edge spanning from said front surface to said rear surface upon said perimeter, a pupil through said at least one layer, said at least one layer being transparent, and having a tapering upon said front surface outwardly from said pupil;
at least one annular electromagnet embedded within said at least one layer;
at least one power receiver in said at least one layer and in electrical communication with said at least one electromagnet,
a radio transmitter capable of signaling said power receiver;
wherein said at least one layer provides a first shape to said lens having a first optical characteristic for distance vision correction and wherein said at least one power receiver supplies a maintenance current to said at least one electromagnet; and,
wherein upon activation of said transmitter, said power receiver energizes and delivers current to said at least one electromagnet providing a second shape to said front surface having a second optical characteristic for near vision correction adding from about +0 diopter to about +3.0 diopters greater than the initial prescription of said lens.

2. The dynamic multiple focus contact lens of claim 1 further comprising:
a first annular electromagnet embedded within said layer proximate said front surface and a power receiver in communication with said first electromagnet;
a second annular electromagnet embedded within said layer proximate said rear surface and a power receiver in communication with said second electromagnet;
said rear surface being adapted to fit upon a portion of a human cornea for vision improvement and said front surface adapted to locate outwardly from a human cornea;
wherein a gap separates said first electromagnet from said second electromagnet in a disengaged position of said lens having the first optical characteristic;
wherein upon activation of said transmitter, each of said power receivers energizes and delivers current to each of said electromagnets attracting said first electromagnet to said second electromagnet wherein a portion of said front surface of said layer swells within said first electromagnet outwardly from said rear surface in an engaged position of said lens having the second optical characteristic; and,
wherein upon inactivation of said transmitter, said first electromagnet separates from said second electromagnet and said layer returns said lens to the disengaged position.

3. The dynamic multiple focus contact lens of claim 2 further comprising:
said front surface and said rear surface having a generally tapered form proximate said perimeter of said lens adapted to fit comfortably upon a human cornea.

4. The dynamic multiple focus contact lens of claim 2 further comprising:
each of said power receivers including one of a loop antenna for resonant inductive coupling, a loop antenna for resonant transfer, and a photovoltaic cell upon said layer in communication with said electromagnets.

5. The dynamic multiple focus contact lens of claim 2 wherein following activation of said transmitter and mutual attraction of said electromagnets, each of said power receivers delivers a maintenance current of lesser magnitude than said current to each of said electromagnets and maintaining said electromagnets in apposition.

6. The dynamic multiple focus contact lens of claim 2 wherein said layer is soft contact lens material.

7. The dynamic multiple focus contact lens of claim 6 wherein said layer is one of hydrogel or silicone-hydrogel.

8. A dynamic multiple focus contact lens, comprising:
a layer of contact lens material suitable for application upon a human cornea, said layer having a generally round shape with a perimeter, a front surface, an opposite rear surface, and an outer edge spanning from said front surface to said rear surface upon said perimeter, a pupil through said at least one layer, said layer being transparent, and having a tapering upon said front surface outwardly from said pupil;
a first annular electromagnet embedded within said layer proximate said front surface and a power receiver in communication with said first electromagnet;
a second annular electromagnet embedded within said layer proximate said rear surface and a power receiver in communication with said second electromagnet;
a radio transmitter capable of signaling said power receivers;
said rear surface being adapted to fit upon a portion of a human cornea for vision improvement and said front surface adapted to locate outwardly from a human cornea;
wherein said layer provides a first shape to said lens having a first optical characteristic for distance vision correction and a gap separates said first electromagnet from said second electromagnet in a disengaged position of said lens and wherein each of said power receivers supply maintenance current to said electromagnets;
wherein upon activation of said transmitter, each of said power receivers energizes and polarizes each of said electromagnets providing a second shape to said front surface having a second optical characteristic for near vision correction from about +0 diopter to about +3.0 diopters and said first electromagnet attracts to said second electromagnet wherein a portion of said front surface of said layer swells within said first electromagnet outwardly from said rear surface in an engaged position of said lens;
wherein following activation of said transmitter and mutual attraction of said electromagnets, each of said power receivers delivers a maintenance current of lesser magnitude than said current to each of said electromagnets and maintaining said electromagnets in apposition;
wherein upon inactivation of said transmitter, said first electromagnet separates from said second electromagnet and said layer returns said lens to the disengaged position;
said front surface and said rear surface having a generally tapered shape proximate said perimeter of said lens adapted to fit comfortably upon a human cornea; and,
said layer either hydrogel or silicone-hydrogel.

9. The dynamic multiple focus contact lens of claim 8 further comprising:
each of said power receivers including one of a loop antenna for resonant inductive coupling, a loop antenna for resonant transfer, and a photovoltaic cell upon said layer in communication with said electromagnets.

10. A dynamic multiple focus contact lens, comprising:
a layer of contact lens material suitable for application upon a human cornea, said layer having a generally round shape with a perimeter, a front surface, an opposite rear surface, and an outer edge spanning from said front surface to said rear surface upon said perimeter, a pupil through said at least one layer, said layer being transparent, and having a tapering upon said front surface outwardly from said pupil;
an annular electromagnet embedded within said layer proximate said front surface and a power receiver in communication with said first electromagnet;
an annular ring of ferrous material embedded within said layer proximate said rear surface;
a radio transmitter capable of signaling said power receiver;
said rear surface being adapted to fit upon a portion of a human cornea for vision improvement and said front surface adapted to locate outwardly from a human cornea;
wherein said layer provides a first shape to said lens having a first optical characteristic for distance vision correction and a gap separates said first electromagnet from said ferrous ring in a disengaged position of said lens;
wherein upon activation of said transmitter, said power receiver energizes and polarizes said electromagnet providing a second shape to said front surface having a second optical characteristic for near vision correction from about +0 diopter to about +3.0 diopters and said electromagnet attracts to said ferrous ring wherein a portion of said front surface of said layer swells within said first electromagnet outwardly from said rear surface in an engaged position of said lens;
wherein following activation of said transmitter and mutual attraction of said electromagnet and said ferrous ring, said power receiver delivers a maintenance current of lesser magnitude than said current to said electromagnet and maintaining said electromagnet in apposition to said ferrous ring;
wherein upon inactivation of said transmitter, said electromagnet separates from said ferrous ring and said layer returns said lens to the disengaged position;
said front surface and said rear surface having a generally tapered shape proximate said perimeter of said lens adapted to fit comfortably upon a human cornea;
said layer either hydrogel or silicone-hydrogel; and,
said power receiver including one of a loop antenna for resonant inductive coupling, a loop antenna for resonant transfer, and a photovoltaic cell upon said layer in communication with said electromagnets.
